(19) United States
(12) Patent Application Publication
(10) Pub. No.: US 2024/0149328 A1
(43) Pub. Date: May 9, 2024

(54) HANDHELD TOOL FOR STRAIGHTENING A FIBER CABLE THAT IS STRUCTURALLY CONFIGURED TO ENHANCE PLACEMENT OF THE FIBER CABLE IN A STRAIGHTENING PATH OF THE TOOL

(71) Applicant: PPC BROADBAND, INC., East Syracuse, NY (US)

(72) Inventors: Daniel DAOUST, Syracuse, NY (US); Darian J. COLLIS, Brick, NJ (US)

(73) Assignee: PPC BROADBAND, INC., East Syracuse, NY (US)

(21) Appl. No.: 18/375,948

(22) Filed: Oct. 2, 2023

Related U.S. Application Data
(60) Provisional application No. 63/378,083, filed on Oct. 2, 2022.

(51) Int. Cl. B21F 1/02

(52) U.S. Cl. CPC B21F 1/02

(57) ABSTRACT

A handheld tool for straightening a cable includes a straightening portion disposed in a housing portion. The straightening portion is configured to define a straightening path that extends in a longitudinal direction through the housing portion, and the straightening portion is structurally configured to engage a fiber cable that extends along the straightening path. The straightening portion is configured to spin freely relative to the housing portion such that the straightening portion is structurally configured to straighten a fiber cable that engages the straightening portion as the fiber cable is moved through the housing in the longitudinal direction. The housing portion is structurally configured to permit access to the straightening path from a direction transverse to the longitudinal direction in order to enhance placement of the fiber cable in the straightening path.

### CROSS-REFERENCE TO RELATED APPLICATION

This application claims the benefit of U.S. Provisional Application No. 63/378,083, filed Oct. 2, 2022, the disclosure of which is hereby incorporated by reference herein in its entirety.

### TECHNICAL FIELD

The present disclosure generally relates to a tool for straightening a cable, and in particular, a handheld tool for straightening a fiber optic cable having an armored jacket.

### BACKGROUND

Fiber optic cables used by CATV providers need to be flexible and pushable to enable technicians with the ability to route such cables. However, such fiber optic cables must also protect the optical fiber(s) disposed within the cable. One type of fiber optic cable includes an armored jacket that protects the optical fiber(s) disposed within the cable and also helps to prevent fiber optic cable from overbending.

However, such cables with armored jackets are typically stored as a coil on a spool/reel and the cable is then unwound by technicians in the field in order to distribute the cable from one point to another point. However, such cables have a tendency to maintain a helix shape even though technicians prefer to lay/distribute a straight cable.

Accordingly, it may be desirable to provide a handheld tool that a technician could use in the field to straighten an unwound cable that retains a helical shape given that the cable was previously stored as a coil on a reel/spool. More particularly, it may be desirable to provide a handheld tool for straightening a cable that is structurally configured to enhance placement of the fiber through the tool.

### SUMMARY

According to various embodiments of the disclosure, a handheld tool for straightening a cable includes a first housing portion pivotally coupled with a second housing portion, a first straightening portion disposed in the first housing portion, and a second straightening portion disposed in the second housing portion. The first straightening portion and the second straightening portion are aligned in a plane that extends from the first housing to the second housing, and the first straightening portion and the second straightening portion are structurally configured to define a straightening path that extends in a longitudinal direction between the first straightening portion and the second straightening portion. The first housing portion and the second housing portion are structurally configured to pivot relative to one another in the plane between an open position and a closed position, and the first straightening portion and the second straightening portion are structurally configured to engage a fiber cable in the closed position. The first straightening portion is structurally configured to spin freely relative to the first and second housing portions, and the second straightening portion is structurally configured to spin freely relative to the first and second housing portions such that the first straightening portion and the second straightening portion are structurally configured to straighten a fiber cable that engages the first straightening portion and the second straightening portion as the fiber cable is moved through the tool in the longitudinal direction. The first housing portion and the second housing portion are structurally configured to pivot to the open position so as to move the first straightening portion away from the second straightening portion in order to enhance placement of the fiber cable in the straightening path.

According to various embodiments of the disclosure, a handheld tool for straightening a cable includes a first straightening portion disposed in a housing portion and a second straightening portion disposed in the housing portion. The first straightening portion and the second straightening portion are aligned in a plane. The first straightening portion and the second straightening portion are configured to define a straightening path that extends in a longitudinal direction through the housing portion between the first straightening portion and the second straightening portion, and the first straightening portion and the second straightening portion are structurally configured to engage a fiber cable that extends along the straightening path. The first straightening portion and the second straightening portion are configured to spin freely relative to the housing portion such that the first straightening portion and the second straightening portion are structurally configured to straighten a fiber cable that engages the first straightening portion and the second straightening portion as the fiber cable is moved through the housing in the longitudinal direction. The housing portion is structurally configured to permit access to the straightening path from a direction transverse to the longitudinal direction in order to enhance placement of the fiber cable in the straightening path.

According to various embodiments of the disclosure, a handheld tool for straightening a cable includes a straightening portion disposed in a housing portion. The straightening portion is configured to define a straightening path that extends in a longitudinal direction through the housing portion, and the straightening portion is structurally configured to engage a fiber cable that extends along the straightening path. The straightening portion is configured to spin freely relative to the housing portion such that the straightening portion is structurally configured to straighten a fiber cable that engages the straightening portion as the fiber cable is moved through the housing in the longitudinal direction. The housing portion is structurally configured to permit access to the straightening path from a direction transverse to the longitudinal direction in order to enhance placement of the fiber cable in the straightening path.

### BRIEF DESCRIPTION OF THE DRAWINGS

Further advantages and features of the present disclosure will become apparent from the following description and the accompanying drawings, to which reference is made. In which are shown:

FIG. 1A is schematic cross-sectional view of a first example armored cable capable of being utilized in various embodiments of a tool of this disclosure.

FIG. 1B is schematic cross-sectional view of a second example armored cable capable of being employed in various embodiments of a tool of this disclosure.

FIG. 1C is schematic cross-sectional view of a third example armored cable capable of being utilized in various embodiments of a tool of this disclosure.

FIG. 1D is schematic cross-sectional view of a fourth example armored cable capable of being employed in various embodiments of a tool of this disclosure.

FIG. 1E is schematic cross-sectional view of a fifth example armored cable capable of being utilized in various embodiments of a tool of this disclosure.

FIG. 2A is a schematic view of an embodiment of a handheld tool for straightening a cable in accordance with various embodiments of this disclosure.

FIG. 2B is a perspective view of portions of the handheld tool of FIG. 2A for straightening in accordance with various embodiments of this disclosure.

FIG. 3 is a front view of portions of the handheld tool for straightening a cable from FIGS. 2A and 2B arranged in accordance with embodiments of this disclosure.

FIG. 4 is a side view of the handheld tool of FIGS. 2A-3 configured in accordance with various embodiments of this disclosure.

FIG. 5 is a perspective view of an exemplary handheld tool for straightening a cable in accordance with various embodiments of this disclosure.

FIG. 6 is a perspective view of the handheld tool of FIG. 5 arranged in accordance with various embodiments of this disclosure to straighten a cable.

FIG. 7 is a side view of the handheld tool of FIGS. 5 & 6 capable of being employed in accordance with various embodiments to straighten a cable.

FIG. 8. is a perspective view of portions of the exemplary handheld tool of FIG. 5 arranged in accordance with various embodiments of this disclosure.

FIG. 9 is an exploded perspective view of an exemplary handheld tool for straightening a cable configured in accordance with various embodiments of this disclosure.

FIG. 10 is a perspective view of the handheld tool of FIG. 9 arranged in accordance with various embodiments of this disclosure.

FIG. 11 is a perspective view of portions of an exemplary handheld tool for straightening a cable in accordance with various embodiments of this disclosure.

FIG. 12 is a line representation of a portion of the handheld tool of FIG. 11 arranged in accordance with various embodiments of this disclosure.

FIG. 13 is a line representation of a portion of the handheld tool of FIG. 11 arranged in accordance with various embodiments of this disclosure.

### DETAILED DESCRIPTION

Reference will now be made in detail to presently preferred compositions, embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

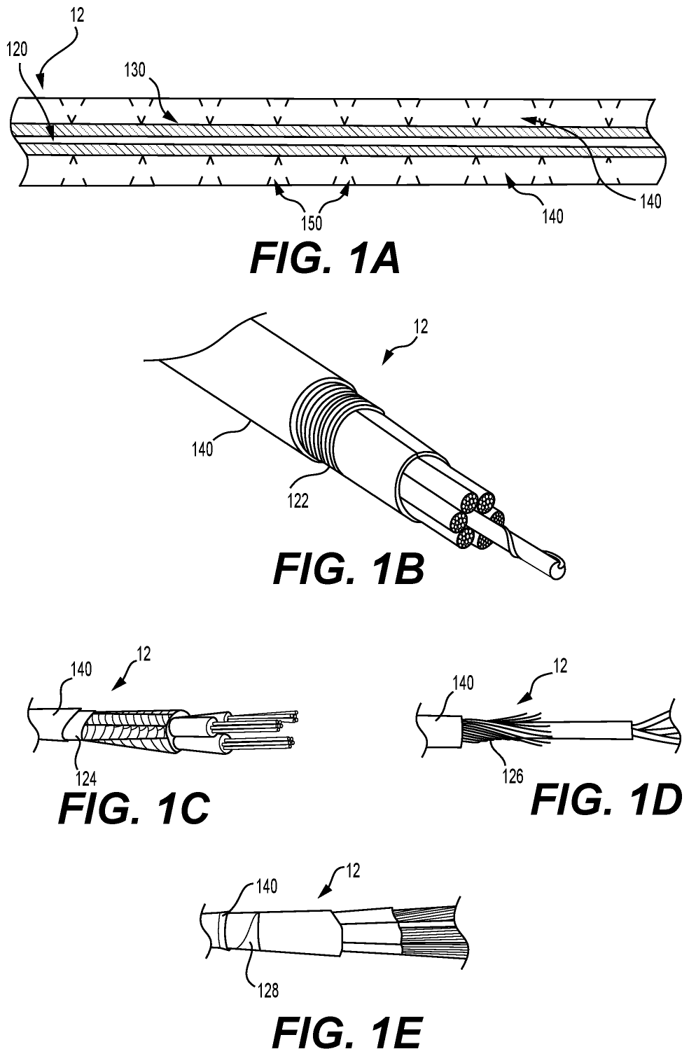

With reference to FIG. 1A, a cable or linear member 12 may include an inner armored layer 130 and an outer polymeric layer 140. The inner armored layer includes an annular cross-section such that a circular channel 120 is formed in the center of the cable. The outer polymeric layer 140 may or may not include a plurality of annular grooves 150, as shown by segmented regions in FIG. 1A, that separate sections of the outer polymeric layer 140. The series of annular grooves 150 causes the outer polymeric layer sections to hinge against each other, such that the linear member 12 can be easily bent to a predetermined bend radius, but a very substantial force must be applied to bend the linear member to a smaller bend radius. The thickness of the outer polymeric layer and the cutting depth of the roller(s) used to form the annular grooves 150 are selected such that the annular grooves 150 extend through substantially all of the outer polymeric layer, such that there is no, or very little, connection between adjacent sections of the outer polymeric layer 140. The advantage of this is that the outer polymeric layer 140 has a limited effect on the bending performance of the linear member 12. Alternatively, the annular grooves 150 may partially extend into the inner armored layer 130.

The inner armored layer 130 and the outer polymeric layer 140 may be formed from materials having different properties, such that the modulus of the material used to form the outer polymeric layer 140 can be significantly greater than the modulus of the material used to form the inner armored layer 130. Careful selection of these materials enables the linear member 12 to be formed such that it does not have the disadvantages inherent in known small diameter liner members 12 and tubes.

When the inner armored layer 130 is configured as a tube, the cable 12 may be formed by extruding the inner armored layer 130 as a tube and then passing the tube through a second extrusion process, during which the outer polymeric layer 140 is formed on the inner armored layer 130. However, it is contemplated that a one-pass co-extrusion process is used to form both the inner armored layer 130 and the outer polymeric layer 140. However, it is understood that the inner armored layer 130 may be formed by: (1) a thin extruded tube 112 as shown in FIG. 1A; (2) a corrugated tube 122 as shown in FIG. 1B; (3) a wire braid armor 124 as shown in FIG. 1C; (4) a layer of single wire armor 126 as shown in FIG. 1D; (5) a steel tape layer armor 128 as shown in FIG. 1E. As noted, the cable 12 is generally stored around a cable spool (not shown) and when the cable 12 is removed from the spool, this type of cable has a tendency to retain a helical shape. The helical shape of the cable 12 includes bends that require a technician and tool in order to straighten such cables 12 in the field.

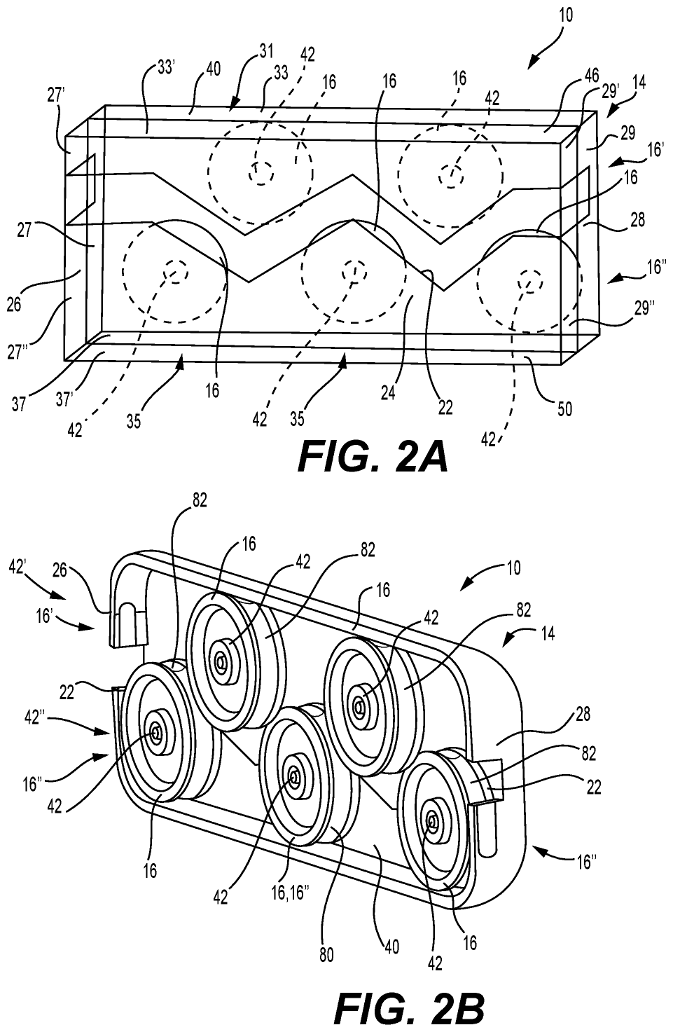

Referring to the embodiments shown in FIGS. 2A-2B, 3, 4, and 5, a handheld tool 10 for straightening a cable 12, such as cable 12 of FIGS. 1A-1E with an armored layer, includes a housing 14 and a straightening portion 16, for example, a plurality of rollers, disposed within the housing 14 wherein the straightening portion 16 includes a first straightening portion 16′, for example, a first set of rollers, that is disposed along the length of an upper axis 18 of the housing 14 while a second straightening portion 16″, for example, a second set of rollers, is disposed along the length of a lower axis 20 of the housing 14 such that the first set of rollers 16′ are offset from the second set of rollers 16″. The housing 14 defines an opening 22 that extends across a front side 24 of the housing 14 and extends into the first lateral side 26 and onto the second lateral side 28. The opening 22 is substantially aligned between the first set of rollers 16′ and the second set of rollers 16″. It is noted that the opening 22 has a varying configuration along the length of the housing 14 that can comprise sections defined by sidewalls configured with linear, curvilinear, or combinations thereof.

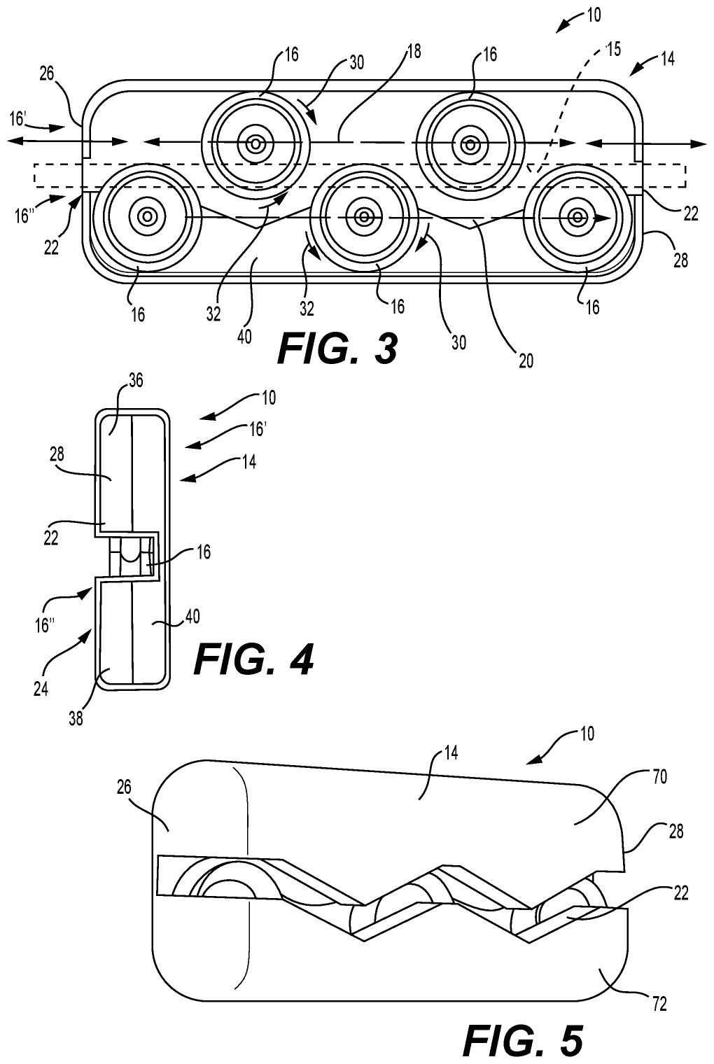

Referring to FIG. 2B and FIG. 3, the intersectional region 17 between the first set of rollers 16′ and the second set of rollers 16″ defines a cable pathway 15 that is configured to receive an armored cable 12. When the cable 12 is pulled between the first linear direction 81 (towards the first lateral side 26) and second linear direction 83 (towards the second lateral side 28), the cable travels along the cable pathway 15 between the first set of rollers and the second set of rollers (within the housing 14).

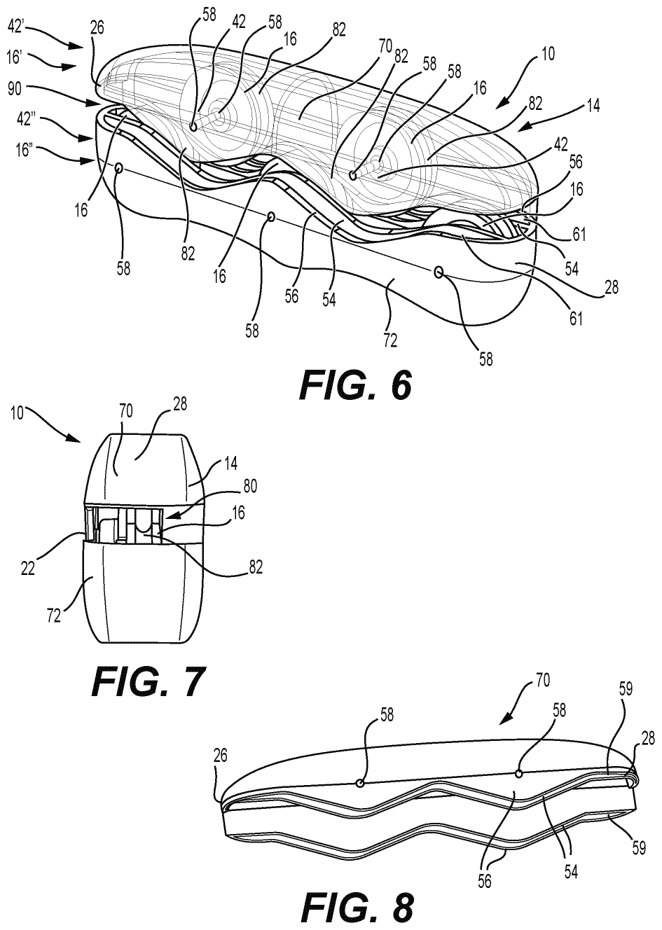

As illustrated by the translucent aspects of the housing 14 in FIG. 6, each roller 16 in the first set of rollers 16′ and in the second set of rollers 16″ includes a circumferential surface 80 wherein a groove 82 is defined along the circumference of each roller 16. The groove 82 is configured to receive the cable 12 when the cable 12 is disposed or sandwiched between the first set of rollers 16′ and second set of rollers 16″. Each roller 16 in the first set of rollers 16′ and in the second set of rollers 16″ is configured to rotate both a first clockwise direction 30 and a second counterclockwise direction 32 relative to the front and rear sides 24, 34 of the housing 14. When the cable 12 is pulled towards the second lateral side 28 of the housing 14, the first set of rollers 16′ rotate in a counterclockwise direction 30 while the second set of rollers 16″ rotate in a clockwise direction 32. However, when the cable 12 is pulled towards the first lateral side 26 of the housing 14, the first set of rollers 16′ rotate in a clockwise direction 32 while the second set of rollers 16″ rotate in a counterclockwise direction 30. As the cable 12 travels between the first set of rollers 16′ and second set of rollers 16′ any bends 37 in the cable are straightened such that the bends 37 are removed. Each roller 16 in the first set of rollers 16′ and in the second set of rollers 16″ is individually mounted within the housing 14.

As shown in FIGS. 2A-2B and 5, the first lateral side 26 of the housing 14 is formed by a first portion 27 of the base member 40, a first portion 27′ of the front upper cover 46, and a first portion 27″ of the front lower cover 50. The second lateral side 28 of the housing 14 is formed by a second portion 29 of the base member 40, a second portion 29′ of the front upper cover 46, and a second portion 29″ of the front lower cover 50. The upper side 31 of the housing 14 is formed by a third portion 33 of the base member 40 and a third portion 33′ of the front upper cover 46. The lower side 35 of the housing 14 is formed by a fourth portion 39 of the base member 40 and a third portion 39′ of the front lower cover 50.

With respect to the particular embodiment shown in FIGS. 2A-4, each roller 16 in the first set of rollers 16′ and in the second set of rollers 16″ is individually and separately mounted to the base member 40. The base member 40 may include a plurality of roller axes 42 that are integral with the inner rear surface of the base member 40 such that the axes 42 for the first set of rollers 16′ are disposed along the length of an upper axis 18 of the housing 14 and the axes 42 for the second set of rollers 16″ is disposed along the length of a lower axis 20 of the housing 14. Alternatively, each roller axis 42 may be separately mounted to the inner rear surface 44 of the base member 40. Regardless, as shown in FIG. 2B, each roller 16 is configured to rotate about a corresponding roller axis 42.

With reference to the side view of the tool 10 shown in FIG. 4, each upper roller axis 42′ spans between the upper front cover 46 and the base member 40 wherein a first end of each upper roller axis 42′ abuts the upper front cover 46 and a second end of each upper roller axis 42′ abuts a rear wall 48 of the base member 40. Similarly, each lower roller axis 42″ spans between the lower front cover 50 and the base member 40 wherein a first end 52 of each lower roller axis 42″ abuts the lower front cover 50 and a second end of each lower roller axis 42″ abuts a rear wall 48 of the base member 40.

The housing 14 in the embodiment shown in FIGS. 2A-4 is formed by a first housing portion 36, or upper housing portion, as shown in FIG. 4, a second housing portion 38, or lower housing portion, as shown in FIG. 4, and a base portion 40 wherein the opening 22 is defined between a portion 19 of the upper housing portion 36 and the lower housing portion 38. Each roller 16 in the first set of rollers 16′ is individually mounted between the upper housing portion 36 and the base portion 40, and each roller 16 in the second set of rollers 16″ is individually mounted between the lower housing portion 38 and the base portion 40. In some aspects, the upper housing portion 36, the lower housing portion 38, and the base member 40 may be coupled together after the rollers are attached via an adhesive, as would be understood by persons skilled in the art. In some aspects, the upper housing portion 36 and the lower housing portion 38 may each be affixed to the base member 40 using a plurality of fasteners (not shown).

With respect to the particular embodiment shown in FIGS. 5-7, the housing 14 is formed by an first housing portion or upper housing member 70 and a second housing portion or lower housing member 72, wherein an opening 22 is defined between a portion 19 of the upper housing member 70 and the lower housing member 72. The upper housing member 70 may be affixed to the lower housing member 72 using a plurality of fasteners. The fasteners may be mechanical fasteners such as screws (not shown) that affix the upper housing member 70 to the lower housing member 72.

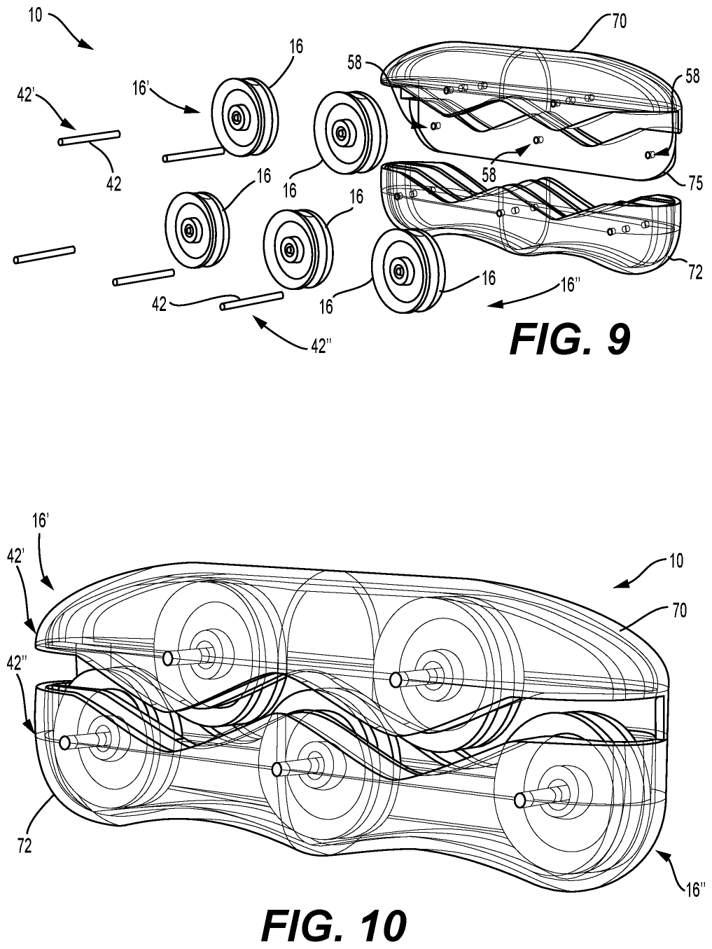

However, the roller axes 42″ may also function as mechanical fasteners that affix the upper housing member 70 to the lower housing member 72, as shown in the exploded view of FIG. 9 and the assembled, perspective view of FIG. 10. The upper housing member 70 may include a flange 75, as shown in FIG. 9, that defines apertures 58 that align with the roller axes 42″ and the apertures 58 of the lower housing member such that the roller axes 42″ also affix the upper housing member 70 to the lower housing member 72.

The first set of rollers 16′ is mounted onto the upper housing member 70 and the second set of rollers 16″ is mounted onto the lower housing member 72. Similar to the other embodiment in FIGS. 2A-4, each roller 16 in the first set of rollers 16′ and the second set of rollers 16″ is individually and separately rotatably mounted to the housing 14 via a corresponding roller axis 42. As shown in FIGS. 6 and 8, each of the upper housing member 70 and the lower housing member 72 include a pair of inner walls 54′, 54″ and a pair of outer walls 56′, 56″. The inner walls 54′ (FIG. 8) of the upper housing member 70 define a plurality of apertures 58 that are aligned with a plurality of corresponding apertures 58 formed in the (front and back) outer walls 56 of the upper housing member 70. The inner walls 54″ (FIG. 6) of the lower housing member 72 define a plurality of apertures 58 that are aligned with a plurality of corresponding apertures 58 formed in the (front and back) outer walls 56 of the lower housing member 72.

In FIG. 6, each upper roller axis 42′ may be disposed in each corresponding set of aligned apertures 58 of the upper housing member 70. Each upper roller axis 42′ is configured to receive an upper roller 16′. Each lower roller axis 42″ may be disposed in each corresponding set of aligned apertures 58 of the lower housing member 72. Each lower roller axis 42″ is configured to receive a lower roller 16″. It is understood that a lower channel 61 or lower recess 61 may be defined between each inner wall 54″ and each outer wall 56″ of the lower cover member. (See FIG. 6). Similarly, an upper channel 59 or upper recess 59 may be defined between each inner wall 54′ and each outer wall 56′ of the upper cover member 36. (See FIG. 8)

The outer wall 56 of the base member 40, the upper cover member 36 and the lower cover member 38 may also define a plurality of apertures 58 to support each axis. Under this circumstance, each upper roller axis 42′ extends between the outer walls 56′ of the upper cover member 36 (and through the inner walls 54 of the upper cover member 36). Similarly, each lower roller axis 42″ extends between the outer walls 56″ of the lower cover member 38 (and through the inner walls 54 (FIG. 6) of the lower cover member 38). In this arrangement the housing 14 provides the additional structure of the inner walls 54′, 54″ to support each roller axis 42 given that each roller axis 42 will be subjected to fairly significant vertical loads as an armored cable 12 is run back and forth through the cable pathway 15 (see region 15 in FIG. 3 for example). The cable pathway 15 is the region between the first and second set of rollers 16′, 16″.

As illustrated in FIGS. 6-10, a straightening groove 90 is defined between the upper housing member 70 and the lower housing member 72. The straightening groove 90 is provided without access to the respective rollers 16, which can correspond with different cable straightening characteristics than passing a cable through the opening 22 that engages the assorted rollers 16. Some embodiments of the straightening groove 90 allow a technician to manually correct cable bends 37 with less severity than if the cable passes through the rollers 16. As such, the tool 10 can provide a technician the ability to selectively straighten a cable to different magnitudes, which can prove advantageous in some installation sites.

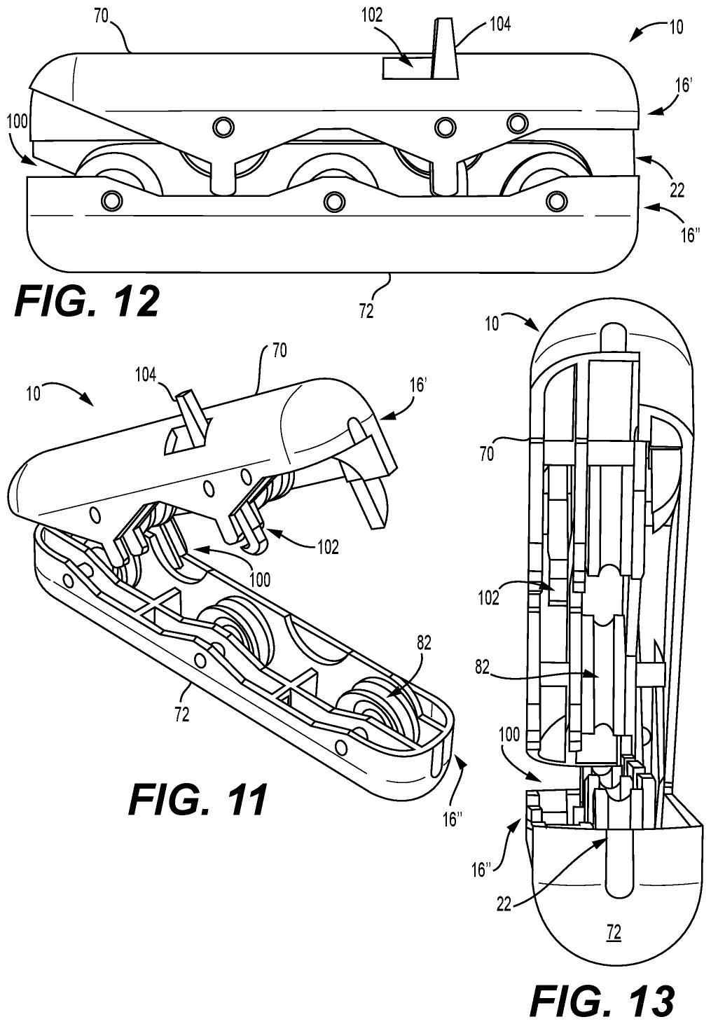

FIGS. 11-13 respectively convey portions of the handheld tool 10 configured in accordance with various embodiments to provide access to the opening 22 between the first straightening portion 16′, for example, the first set of rollers, and the second straightening portion 16″, for example, the second set of rollers. As shown in the perspective view of FIG. 11, the housing 14 can be configured to separate the second housing portion or lower housing member 72 from the first housing portion or upper housing member 70 to provide visual and physical access to the opening 22 and the respective roller grooves 82. While the tool 10 of FIGS. 11-13 are illustrated with a hinge 100, such configuration is not required or limiting as the respective housing members 70/72 can be arranged to separate selectively with other mechanisms, such as a removable fastener, strap, or keyed joint.

The process of separating the respective housing members 70/72 from one another can include engaging one or more selection mechanisms 102. In the embodiment shown in FIGS. 11-13, the selection mechanism 102 is a selectable trigger including a lever 104 that continuously extends through the upper housing member 72 to secure to the lower housing member 70. It is contemplated, but not required, that the selection mechanism 102 has one or more force features, such as a spring or magnet, that applies continuous force onto the lever 104 to physically connect the respective housing member 70/72, as shown in FIG. 12.

In the side view of FIG. 13, the respective housing members 70/72 are separated to present an open configuration where a technician can access the respective rollers 16, opening 22, and straightening groove 90. Other embodiments arrange the tool hinge 100 to allow the upper housing member 72 to rotate around a longitudinal axis of the housing 14, which would be ninety degrees different than the embodiment shown in FIGS. 11 and 13 where the upper housing member 72 rotates in the longitudinal plane of the lower housing member 70.

Regardless of how the respective housing members 70/72 separate, the ability to selectively open and close the tool to access the rollers 16 and opening 22 allows for efficient cleaning, maintenance, or use. For instance, a technician may open the tool 10 to straighten less than an entire length of a cable 12, which would be more difficult with a non-pivoting tool. That is, pivoting the upper housing member 72 allows a technician to selectively place a section of cable 12 in the opening 22 before closing the tool 10 and pulling the cable 12 to straighten at least one turn 37. Conversely, a continuously closed tool 10 would involve pulling an end of a cable 12 through the entirety of the opening 22, which would create a straightened cable 12 end that may not be desirable in some installation applications.

While multiple exemplary, non-limiting embodiments have been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A handheld tool for straightening a cable that is structurally configured to enhance placement of the fiber through the tool, comprising:
a first housing portion pivotally coupled with a second housing portion;
a first straightening portion disposed in the first housing portion;
a second straightening portion disposed in the second housing portion;
wherein the first straightening portion and the second straightening portion are aligned in a plane that extends from the first housing to the second housing;
wherein the first straightening portion and the second straightening portion are structurally configured to define a straightening path that extends in a longitudinal direction between the first straightening portion and the second straightening portion;
wherein the first housing portion and the second housing portion are structurally configured to pivot relative to one another in the plane between an open position and a closed position;
wherein the first straightening portion and the second straightening portion are structurally configured to engage a fiber cable in the closed position;
wherein the first straightening portion is structurally configured to spin freely relative to the first and second housing portions, and the second straightening portion is structurally configured to spin freely relative to the first and second housing portions such that the first straightening portion and the second straightening portion are structurally configured to straighten a fiber cable that engages the first straightening portion and the second straightening portion as the fiber cable is moved through the tool in the longitudinal direction; and
wherein the first housing portion and the second housing portion are structurally configured to pivot to the open position so as to move the first straightening portion away from the second straightening portion in order to enhance placement of the fiber cable in the straightening path.

2. The handheld tool of claim 1, wherein the first straightening portion includes a first roller positioned along a first longitudinal axis of the first housing portion, and the second straightening portion includes a second roller positioned along a second longitudinal axis of the second housing portion; and
wherein the first longitudinal axis is separated from the second longitudinal axis in the plane.

3. The handheld tool of claim 2, wherein the first roller is structurally configured to rotate around a first pin that extends through the first housing portion and the second roller is structurally configured to rotate around a second pin that continuously extends through the second housing portion.

4. The handheld tool of claim 3, wherein the first pin is spaced apart from the second pin in the longitudinal direction.

5. The handheld tool of claim 1, wherein the first straightening portion is structurally configured to overlap the second straightening portion along the straightening path in a direction perpendicular to the longitudinal direction.

6. The handheld tool of claim 1, wherein the first housing portion and the second housing portion are structurally configured to define a receiving portion that is structurally configured to extend along a length of the first housing portion and the second housing portion in the longitudinal.

7. The handheld tool of claim 6, wherein the receiving portion comprises an opening between the first housing portion and the second housing portion that is structurally configured to align with the straightening path.

8. A handheld tool for straightening a cable that is structurally configured to enhance placement of the fiber through the tool, comprising:
a first straightening portion disposed in a housing portion;
a second straightening portion disposed in the housing portion;
wherein the first straightening portion and the second straightening portion are aligned in a plane;
wherein the first straightening portion and the second straightening portion are configured to define a straightening path that extends in a longitudinal direction through the housing portion between the first straightening portion and the second straightening portion;
wherein the first straightening portion and the second straightening portion are structurally configured to engage a fiber cable that extends along the straightening path;
wherein the first straightening portion and the second straightening portion are configured to spin freely relative to the housing portion such that the first straightening portion and the second straightening portion are structurally configured to straighten a fiber cable that engages the first straightening portion and the second straightening portion as the fiber cable is moved through the housing in the longitudinal direction; and
wherein the housing portion is structurally configured to permit access to the straightening path from a direction transverse to the longitudinal direction in order to enhance placement of the fiber cable in the straightening path.

9. The handheld tool of claim 8, wherein the first straightening portion includes a first roller positioned along a first longitudinal axis of the housing and the second straightening portion includes a second roller positioned along a second longitudinal axis of the housing; and
wherein the first longitudinal axis is separated from the second longitudinal axis in the plane.

10. The handheld tool of claim 9, wherein the first roller is structurally configured to rotate around a first pin that extends through the housing and the second roller is structurally configured to rotate around a second pin that extends through the housing.

11. The handheld tool of claim 10, wherein the first pin is spaced apart from the second pin in the longitudinal direction.

12. The handheld tool of claim 8, wherein the first straightening portion is structurally configured to overlap the second straightening portion along the straightening path in a direction perpendicular to the longitudinal direction.

13. The handheld tool of claim 8, wherein the housing portion is structurally configured to define a receiving portion that is structurally configured to extend along a length of the housing portion in the longitudinal.

14. The handheld tool of claim 13, wherein the receiving portion comprises an opening in the housing that is structurally configured to align with the straightening path.

15. The handheld tool of claim 8, wherein the housing portion comprises a first housing portion configured to be pivotally coupled with a second housing portion;
wherein the first housing portion and the second housing portion are structurally configured to pivot relative to one another in the plane between an open position and a closed position; and
wherein the first straightening portion and the second straightening portion are structurally configured to engage a fiber cable in the closed position.

16. The handheld tool of claim 15, wherein the first housing portion and the second housing portion are structurally configured to pivot to the open position so as to move the first straightening portion away from the second straightening portion in order to enhance placement of the fiber cable in the straightening path.

17. The handheld tool of claim 15, wherein the first straightening portion is disposed in the first housing portion, and the second straightening portion is disposed in the second housing portion.

18. A handheld tool for straightening a cable that is structurally configured to enhance placement of the fiber through the tool, comprising:
a straightening portion disposed in a housing portion;
wherein the straightening portion is configured to define a straightening path that extends in a longitudinal direction through the housing portion;
wherein the straightening portion is structurally configured to engage a fiber cable that extends along the straightening path;
wherein the straightening portion is configured to spin freely relative to the housing portion such that the straightening portion is structurally configured to straighten a fiber cable that engages the straightening portion as the fiber cable is moved through the housing in the longitudinal direction; and
wherein the housing portion is structurally configured to permit access to the straightening path from a direction transverse to the longitudinal direction in order to enhance placement of the fiber cable in the straightening path.

19. The handheld tool of claim 18, wherein the straightening portion includes a first roller positioned along a first longitudinal axis of the housing and a second roller positioned along a second longitudinal axis of the housing; and
wherein the first longitudinal axis is separated from the second longitudinal axis in the plane.

20. The handheld tool of claim 19, wherein the first roller is structurally configured to rotate around a first pin that extends through the housing and the second roller is structurally configured to rotate around a second pin that extends through the housing.

21. The handheld tool of claim 20, wherein the first pin is spaced apart from the second pin in the longitudinal direction.

22. The handheld tool of claim 18, wherein the first straightening portion is structurally configured to overlap the second straightening portion along the straightening path in a direction perpendicular to the longitudinal direction.

23. The handheld tool of claim 18, wherein the housing portion is structurally configured to define a receiving portion that is structurally configured to extend along a length of the housing portion in the longitudinal.

24. The handheld tool of claim 23, wherein the receiving portion comprises an opening in the housing that is structurally configured to align with the straightening path.

25. The handheld tool of claim 18, wherein the housing portion comprises a first housing portion configured to be pivotally coupled with a second housing portion;
wherein the first housing portion and the second housing portion are structurally configured to pivot relative to one another in the plane between an open position and a closed position; and
wherein the straightening portion is structurally configured to engage a fiber cable in the closed position.

26. The handheld tool of claim 25, wherein the straightening portion includes a first straightening portion disposed in the first housing portion and a second straightening portion disposed in the second housing portion.

27. The handheld tool of claim 26, wherein the first housing portion and the second housing portion are structurally configured to pivot to the open position so as to move the first straightening portion away from the second straightening portion in order to enhance placement of the fiber cable in the straightening path.

28. The handheld tool of claim 26, wherein the first straightening portion is disposed in the first housing portion, and the second straightening portion is disposed in the second housing portion.
